(19) United States
(12) Patent Application Publication
(10) Pub. No.: US 2010/0138750 A1
(43) Pub. Date: Jun. 3, 2010

(54) PRESENTING NETWORK PERFORMANCE DATA IN THE CONTEXT OF A MAP OF PATH MODEL OBJECTS

(75) Inventor: David S. Trinler, Fairview, TX (US)

Correspondence Address: MICHAEL A DESANCTIS;HAMILTON DESANCTIS & CHA LLP, FINANCIAL PLAZA AT UNION SQUARE, 225 UNION BOULEVARD, SUITE 305, LAKEWOOD, CO, 80228, US

(73) Assignee: XTERA COMMUNICATIONS, INC., Allen, TX (US)

(21) Appl. No.: 12/352,363

(22) Filed: Jan. 12, 2009

Related U.S. Application Data
(60) Provisional application No. 61/118,651, filed on Nov. 30, 2008.

(51) Int. Cl. G06F 3/048

(52) U.S. Cl. 715/736

(57) ABSTRACT

Methods and systems for improved visual presentation and organization of network performance data are provided. According to one embodiment, a method is provided for displaying performance data. Information is received regarding a selected path of multiple paths associated with network elements that are part of a service provider network (e.g., a DWDM network). A map of the selected path is displayed responsive to receipt of the information regarding the selected path. The map of the selected path includes (i) graphical representations of participating network elements of the network elements that are associated with the selected path and (ii) graphical representations of client ports, line ports and port connections associated with the participating network elements. Along with the map, information regarding performance data associated with the participating network elements is also displayed. The performance data includes optical power levels upon entry to and exit from each of the participating network elements.

### CROSS-REFERENCE TO RELATED APPLICATIONS

This application claims the benefit of U.S. Provisional Application No. 61/118,651 filed on Nov. 30, 2008, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the United States Patent and Trademark Office patent files or records, but otherwise reserves all rights to the copyright whatsoever. Copyright© 2008-2009, Xtera Communications, Inc.

### BACKGROUND

1. Field

Embodiments of the present invention generally relate to telecommunications network management and network management graphical user interfaces (GUIs). In particular, embodiments of the present invention relate to remote monitoring and visually depicting performance data at various levels of a network model from a path level to individual ports of network elements to facilitate trouble shooting and diagnostic operations by network operations center (NOC) personnel, for example, of an optical network, such as a dense wavelength-division multiplexing (DWDM) transport network.

2. Description of the Related Art

FIG. 1. conceptually illustrates a simplified service provider network topology 100 in which embodiments of the present invention may be employed. In the present example, the service provider network may represent an ultra-long haul network, long-haul network, regional network, metropolitan area network (MAN), access network or a combination or subset of one or more of these network types. The service provider network 100 includes multiple optical switching platforms 105a-d, optical transport platforms 110a-c and optical services multiplexers 115a-d physically coupled by various linear, ring and mesh connections. An example of a metro core optical switching platform is the XTERA® 7200 OSP™ available from Xtera Communications, Inc. of Allen, Tex., USA. Examples of metro regional optical transport platforms include the Xtera 5400 OTP™ and the Xtera 6400 OTP™, both available from Xtera Communications, Inc. An example of a metro access optical service multiplexer is the Xtera 3300 OSM™ available from Xtera Communications, Inc. In addition to or instead of the equipment identified above, the service provider network 100 may also include one or more Nu-Wave CXR systems (not shown), Nu-Wave ES systems (not shown) and/or Nu-Wave XLS systems (not shown) each of which is available from Xtera Communications, Inc.

The service provider network 100 also include a network management system 120, which may be used by network operations center (NOC) personnel to perform various network management functions. Network management system 120 may be, among other things, a dumb terminal, a personal computer running a terminal emulator or a personal computer or workstation running a network management application. Network management system 120 may be coupled in communication with one or more Internet Protocol addressable network elements of the service provider network 100 serially (e.g., using a null modem or modem connection to a serial port), directly (e.g., via direct TCP/IP connection and/or a TL-1 session) or indirectly (e.g., via a remote TCP/IP connection and/or a TL-1 session). Network management is a time-consuming task involving, among other things, planning, installation, test and turn-up, remote monitoring, performance monitoring, service provisioning, fault management, security, diagnostics and network maintenance.

FIG. 2 is a screen shot of an existing network element-level performance monitor interface. In this state-of-the-art network element-level performance monitor interface, a performance monitor window 200 includes an area 210 containing a representation of a network tree, an area 220 listing network elements and access identifiers (AIDs) for a selected subnetwork 211 and an area providing a tabular listing of optical power level values 240 for the selected AID in the selected subnetwork 211 and for a selected monitored type 230. This type of performance monitoring interface is useful for various trouble shooting activities involving physical pieces of equipment in the network 100 and/or intra network element trouble shooting activities, but does not facilitate trouble shooting at a logical level involving paths, path segments, routes, line connections and/or client connections within the network 100. Obtaining information for such logical objects requires NOC personnel to repeatedly traverse the network tree and request the desired performance data for each AID associated with the desired logical object. For large paths, such a manual process is tedious and error prone.

FIG. 3 is another screen shot 300 of an existing network element-level performance monitor interface. Performance monitor window 300 provides an area 310 containing a representation of a network tree, an area 320 listing AIDs for a selected network element 311 and an area providing a tabular listing of optical power level values 350 for a selected AID 321 in the selected network element 311 and for a selected monitored type 340. As in the case of performance monitor window 200, this type of performance monitoring interface is useful primarily for trouble shooting activities involving physical pieces of equipment in the network 100 and/or intra network element trouble shooting activities. Again, trouble shooting at a logical level involving paths, path segments, routes, line connections and/or client connections within the network 100 requires much care and effort on the part of NOC personnel.

Thus, there is a need in the art for improved interfaces for presenting and organizing network performance data.

### SUMMARY

Methods and systems are described for improved visual presentation and organization of network performance data. According to one embodiment, a method is provided for displaying performance data. Information is received regarding a selected path of multiple paths associated with multiple network elements that are part of a service provider network. A map of the selected path is displayed responsive to receipt of the information regarding the selected path. The map of the selected path includes (i) graphical objects representing participating network elements of the network elements that are associated with the selected path and (ii) graphical representations of client ports, line ports and port connections associated with the participating network elements. Along with the map, information regarding performance data associated with the participating network elements is also displayed. The performance data includes optical power levels upon entry to and exit from each of the participating network elements.

In the aforementioned embodiment, the display of information regarding performance data associated with the participating network elements involves displaying the information for a first signal direction and/or a second signal direction responsive to a user request.

In the context of various of the aforementioned embodiments, the network elements may include terminal equipment and the display of a map of the selected path may further involve displaying one or more transponders associated with participating terminal equipment that are associated with the selected path.

In various instances of the aforementioned embodiments, the network elements may include one or more of terminal equipment, optical amplifiers, optical add/drop multiplexers (OADMs) and optical cross-connects (OXCs).

In some embodiments, the service provider network may be a dense wavelength-division multiplexing (DWDM) transport network.

Other embodiments of the present invention provide another method of displaying performance data. Performance data associated with multiple network elements that are part of a service provider network is received. The performance data includes information regarding optical power levels at one or more performance monitoring data points associated with the plurality of network elements. A graphical depiction is caused to be presented which illustrates the network elements and their physical interconnections via respective line ports and client ports. Concurrently with the graphical depiction, information regarding the received performance data is also caused to be displayed.

In the aforementioned embodiment, information may be received regarding a selected path of multiple paths through the service provider network and the network elements displayed are those network elements within the service provider network that are associated with the selected path.

In various instances of the aforementioned embodiments, causing information regarding the received performance data to be displayed may involve displaying the information for a first signal direction and/or a second signal direction.

In the context of various of the aforementioned embodiments, the service provider network may be a wavelength-division multiplexing (WDM), a coarse WDM (CWDM) or a dense WDM (DWDM) transport network.

In some instances, the network elements may include terminal equipment, optical amplifiers, optical add/drop multiplexers (OADMs) and/or optical cross-connects (OXCs).

Other embodiments of the present invention provide a network management system including a storage device and one or more processors. The storage device has stored thereon one or more routines operable to collect and display performance data associated with network elements of a service provider network. The one or more processors are coupled to the storage device and are configured to execute the one or more routines to cause to be concurrently presented to an end user of the network management system (i) a map of a selected path and (ii) information regarding performance data associated with participating network elements of the network elements that are associated with the selected path. The end user identifies the selected path from multiple paths associated with the network elements. The map includes (i) graphical objects representing the participating network elements and (ii) graphical representations of client ports, line ports and port connections associated with the participating network element. The information regarding performance data includes optical power levels upon entry and exit from each of the participating network elements.

Other embodiments of the present invention provide a program storage device readable by one or more processors of a network management system, tangibly embodying a program of instructions executable by the one or more processors to perform method steps for displaying performance data associated with network elements associated with a selected path. When the program of instructions are executed by the one or more processors, information is received regarding a selected path of multiple paths associated with multiple network elements that are part of a service provider network. Responsive to receipt of the information regarding the selected path, a map of the selected path is displayed including (i) graphical objects representing participating network elements that are associated with the selected path and (ii) graphical representations of client ports, line ports and port connections associated with the participating network elements. Along with the map, information is also displayed regarding performance data associated with the participating network elements. The performance data includes optical power levels upon entry and exit from each of the participating network elements.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 conceptually illustrates a simplified service provider network topology in which embodiments of the present invention may be employed.

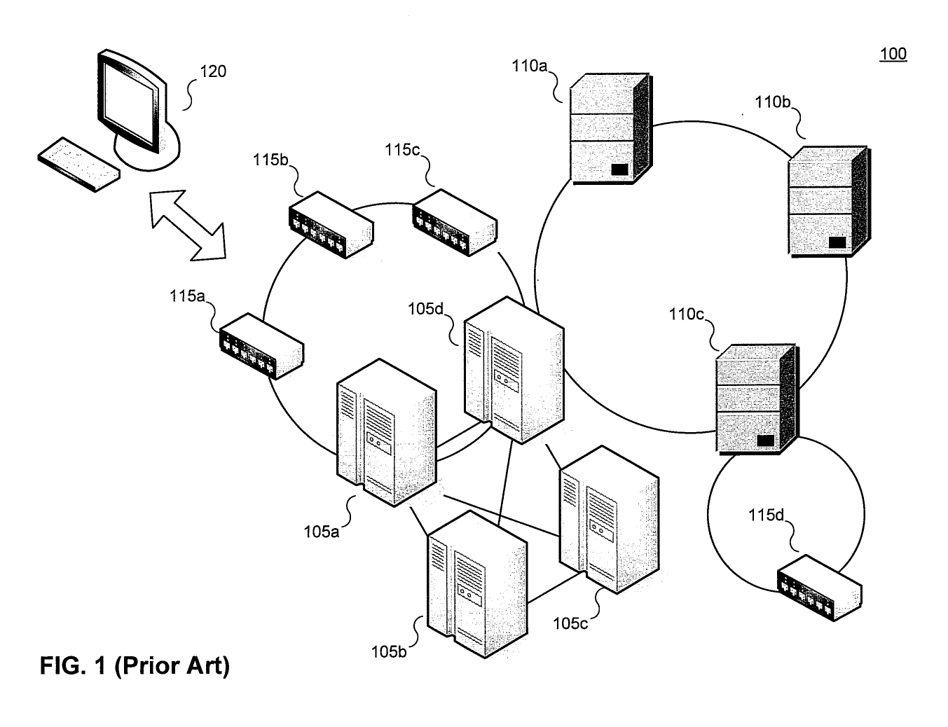

FIG. 2 is a screen shot of an existing network element-level performance monitor interface.

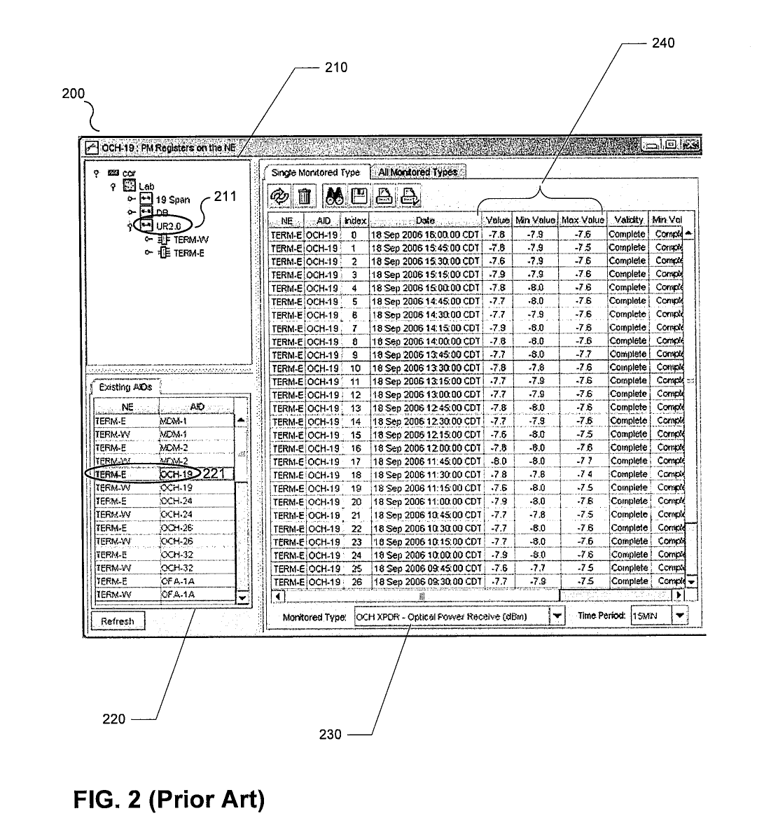

FIG. 3 is another screen shot of an existing network element-level performance monitor interface.

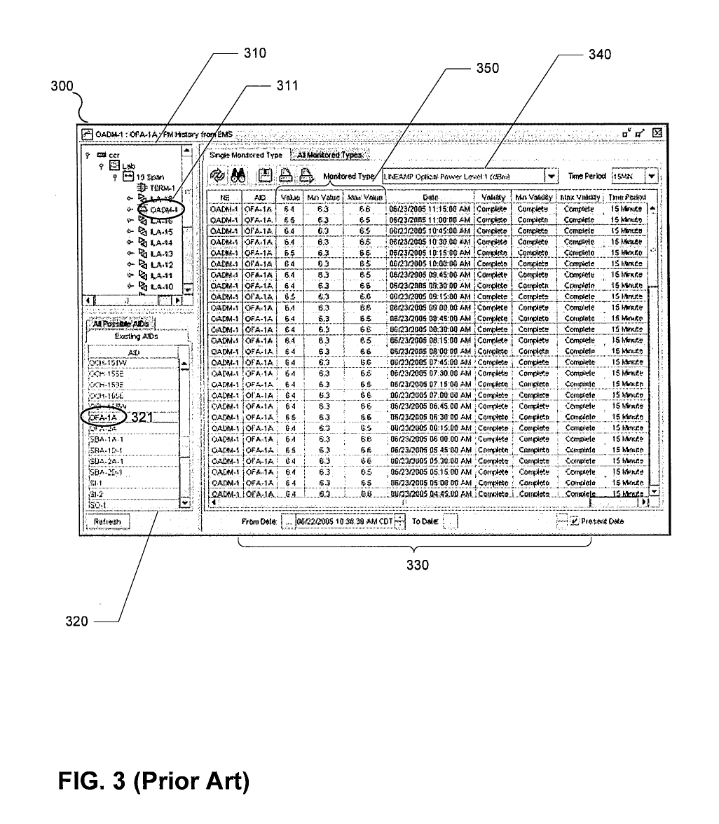

FIG. 4 is a diagram illustrating the relationship of various objects in a path model in accordance with various embodiments of the present invention.

FIG. 5 is a screen shot of a graphical performance monitor viewer of a network management system in accordance with embodiments of the present invention.

FIG. 6 is another screen shot of a graphical performance monitor viewer of a network management system in accordance with embodiments of the present invention.

FIG. 7 illustrates invocation of a performance monitor viewer from a path model representation of a network tree in accordance with embodiments of the present invention.

FIG. 8 illustrates invocation of a performance monitor viewer from a network model representation of a network tree in accordance with embodiments of the present invention.

FIG. 9 is an example of a computer system with which embodiments of the present invention may be utilized.

FIG. 10 is a flow diagram illustrating performance monitoring processing in accordance with embodiments of the present invention.

### DETAILED DESCRIPTION

Methods and systems are described for improved visual presentation and organization of network performance data. According to one embodiment, in order to facilitate trouble shooting and diagnostic operations by network operations center (NOC) personnel at the path level and at lower levels of a path model, network elements are treated as black boxes with client and line ports that enter and exit. In this manner, optical power levels, for example, can be isolated and identified at particular points for a selected path, segment, client connection, route or line connection.

While, for sake of illustration, various embodiments of the present invention are discussed in the context of wavelength-division multiplexing (WDM) (e.g., dense wavelength-division multiplexing (DWDM) and coarse wavelength-division multiplexing (CWDM)), it is to be understood that embodiments of the present invention may be implemented and deployed in the context of a variety of other types of communications networks including those that work completely in the optical domain and those that switch between the optical and electrical domains and including repeatered and unrepeatered networks. Additionally, it is to be understood that the performance monitoring solution described herein is applicable to network elements supporting all data rates and Optical Carrier (OC) specifications in use (e.g., OC-1, OC-3, OC-3c, OC-12, OC-24, OC-48, OC-96, OC-192, OC-768 and beyond) and unused (e.g., OC-384, OC-1536 and OC-3072) and all signal formats (e.g., Synchronous Optical NETwork (SONET), Synchronous Digital Hierarchy (SDH), fiber distributed data interface (FDDI), Fibre Channel, Ethernet, Gigabit Ethernet, 10 Gigabit Ethernet (10 GbE), digital, analog, RF and the like).

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

### Terminology

Brief definitions of terms used throughout this application are given below.

The term “client” generally refers to an application, program, process or device in a client/server relationship that requests information or services from another program, process or device (a server) on a network. Importantly, the terms “client” and “server” are relative since an application may be a client to one application but a server to another. The term “client” also encompasses software that makes the connection between a requesting application, program, process or device to a server possible.

The phrase “client connection” generally refers to a logical connection between two client ports. In one embodiment, client connections are created by a network manager as client fiber connections are made between subnetworks.

The terms “connected” or “coupled” and related terms are used in an operational sense and are not necessarily limited to a direct connection or coupling.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

The phrase “line connection” generally refers to a logical connection between two line ports. Depending upon the particular implementation and equipment involved, line connections may be automatically or manually created using a network manager.

If the specification states a component or feature “may”, “can”, “could”, or “might” be included or have a characteristic, that particular component or feature is not required to be included or have the characteristic.

The term “network” generally refers to a configuration of data processing devices and software connected for information interchange. In some embodiments, multiple types of networks may be employed, including one or more of (i) a public communication network, such as the Internet and (ii) a private optical network (e.g., a wavelength-division multiplexing (WDM), coarse wavelength-division multiplexing (CWDM) or dense wavelength-division multiplexing (DWDM) network) managed and operated by a service provider. Depending upon the context, the term network may be used in a general sense or refer to one or more of the specific types of networks mentioned above.

The phrase “network element” generally refers to a single Internet Protocol (IP) addressable piece of equipment in a network. In the context of various embodiments of the present invention, network elements include terminal equipment, optical add-drop multiplexers (OADMs), inline amplifiers, optical cross-connects (OXCs) and the like, of a WDM, CWDM or DWDM transport system.

The term “path” generally refers to a logical, end-to-end traffic channel that enters and exists a network at two specific client ports. A path can traverse multiple subnetworks as it travels across the network. A path contains one or more path segments and the client connections that exist between them.

The phrase “path segment” or the term “segment” generally refers to a logical object, which represents an end-to-end traffic channel that enters and exits a single subnetwork. A path segment or segment contains two client ports and one route.

The term “route” generally refers to a logical object, which represents a channel through a single subnetwork. A route contains two or more network elements, line ports and the line port connections between them. In one embodiment, an instance of a route exists for each channel in a subnetwork.

The term “responsive” includes completely or partially responsive.

The term “server” generally refers to an application, program, process or device in a client/server relationship that responds to requests for information or services by another program, process or device (a server) on a network. The term “server” also encompasses software that makes the act of serving information or providing services possible.

The term “subnetwork” generally refers to an object that represents a group of one or more network elements. In various embodiments of the present invention, a subnetwork comprises a group of network elements that are directly or indirectly connected by their respective line ports.

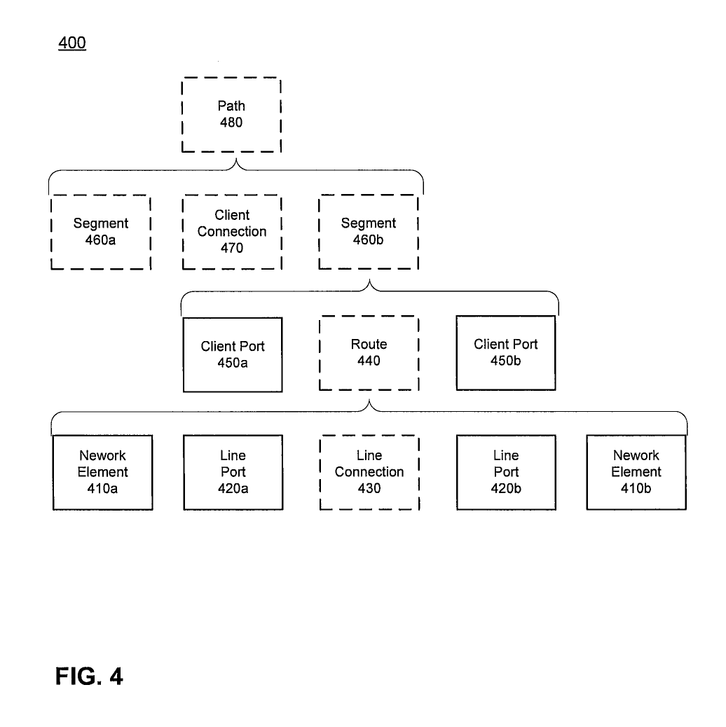

Turning to FIG. 4, the relationships of various objects in a path model in accordance with various embodiments of the present invention will now be described with reference to a path model objects tree 400. In one embodiment of the present invention, a network management system (NMS), such as NMS 120, and its associated graphical user interface use a path model, including multiple path model objects, to represent logical and physical pieces that make up the paths that travel through a service provider network. In the context of the present example, logical elements of path model objects tree 400 have dashed borders and physical elements have solid borders.

According to the present example, a path object 480 is the highest level of abstraction and the root of the path model objects tree 400. Path objects, such as path object 480, represent end-to-end traffic channels that enter and exit a service provider network at two specific client ports. Path objects may contain one or more segment objects, such as segment object 460a and segment object 460b, from the next lower layer of abstraction in the path model objects tree 400. When a particular path object contains more than one segment object, such as segment object 460a and segment object 460b, a client connection object, such as client connection object 470 represents the logical connection between client ports (e.g., physical interfaces that connect segments) associated with the segment objects.

Moving down the path model objects tree 400 to a lower level of abstraction, according to the present example, one or more segment objects (e.g., segment objects 460a and 460b) and a client connection object (e.g., client connection object 470) for each pair of segment objects are objects representing the next level of abstraction. Segment objects 460a and 460b each represent an end-to-end traffic channel that enters and exits a single subnetwork. A segment object contains two client ports, e.g., client port object 450a and client port object 450b, and one route object, e.g., route object 440, from the next lower layer of abstraction in the path model objects tree 400.

According to the present example, the next lower level of abstraction of the path model objects tree 400 includes client port objects (e.g., client port objects 450a and 450b) and a route object (e.g., route object 440) for each pair of client port objects. Route objects represent a channel through a single subnetwork containing two or more network elements (e.g., network elements 410a and 410b), line ports (e.g., line ports 420a and 420b) and the line port connection objects (e.g., line connection object 430) between corresponding pairs of line ports from the lowest layer of abstraction in the path model objects tree 400.

The lowest layer of abstraction of the path model objects tree 400, includes network elements (e.g., network elements 410a and 410b), line ports (e.g., physical interfaces that connect network elements) and line connection objects (e.g., line connection object 430) for each corresponding pair of line ports. As indicated above, a network element is typically a single Internet Protocol (IP) addressable piece of equipment in a network. In the context of various embodiments of the present invention, network elements include terminal equipment, optical add-drop multiplexers (OADMs), inline amplifiers, optical cross-connects (OXCs) and the like, of a WDM, CWDM or DWDM transport system.

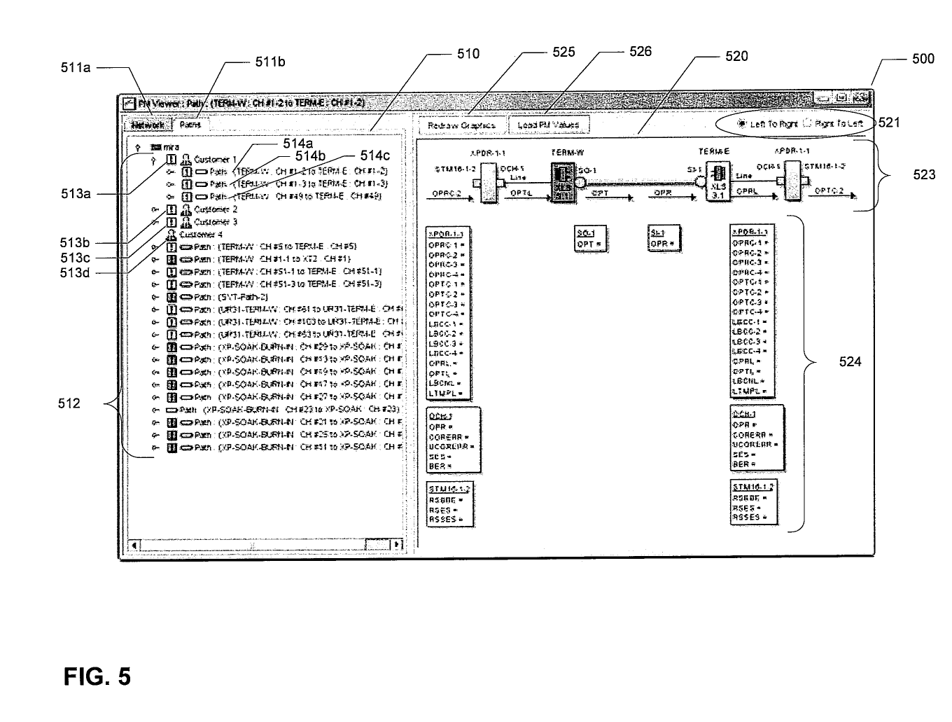

FIG. 5 is a screen shot of graphical performance monitor viewer 500 of a network management system in accordance with embodiments of the present invention. In the present example, the graphical performance monitor viewer 500 includes two distinct windows, (i) a tree hierarchy window 510, which can contain a graphical depiction of either a network tree or a path tree depending upon the selected tab 511a or 511b and (ii) a map window 520. In the present example, the “Path” tab 511b is the active tab for the tree hierarchy window 510 and thus the tree hierarchy window 510 depicts a path tree hierarchy 512 in accordance with a path model, such as that described with reference to path model objects tree 400 in FIG. 4.

The path tree hierarchy 512 depicts all customers 513a-d managed by the network management system. By expanding a customer, e.g., customer 513a, NOC personnel are able to view all paths, e.g., paths 514a-c, owned by the parent customer. In one embodiment, the paths can be further expanded to reveal all segments (not shown) and client connections (not shown) that belong to the parent path. Likewise, segments (not shown) can be further expanded to show client ports (not shown) and routes (not shown) for the parent segment.

Map window 520 provides a graphical map representation 523 of the selected object (e.g., path 514a) in the path tree hierarchy 512. In one embodiment, the graphical map representation 523 includes all network elements (e.g., TERM-W and TERM-E) participating in or otherwise associated with the selected path (e.g., path 514a). In some embodiments, optical line cards (e.g., transponders, such as XPDR 1-1) associated with the terminal equipment may also be graphically depicted.

In the present example, under each graphic object of graphical map representation 523, a collection of current performance monitoring data values 524 are shown for the corresponding element. In one embodiment, the current performance monitoring data values 524 include all performance monitoring data points along the selected path. In other embodiments, various filters may be applied by NOC personnel to limit or expand the types of performance monitoring data displayed. Examples of relevant performance monitoring data values include, but are not limited to, optical power levels at the point of reception at client ports (e.g., OPRC-1, OPRC-2, OPRC-3 and OPRC-4), optical power levels at the point of transmission from client ports (e.g., OPTC-1, OPTC-2, OPTC-3 and OPTC-4), laser bias current (e.g., LBCC-1, LBCC-2, LBCC-3 and LBCC-4), corrected errors for a particular optical channel (e.g., CORERR), uncorrectable errors for a particular optical channel (e.g., UCORERR), laser temperature (e.g., laser temperature line (LTMPL)), background block errors (e.g., regenerator section background block errors (RSBBE)), Severely Errored Seconds (SES) (e.g., regenerator section SES (RSSES)) and Bit Error Rate (BER).

According to some embodiments, in addition to or instead of presenting textual or numeric information regarding performance data values, gauges, bar charts or the like can be presented to illustrate the current performance data values with reference to predetermined or configurable tolerances, norms, ranges, and/or alarm limits.

According to the present example, the current performance monitoring data values 524 can be refreshed by selecting the “Load PM Values” button 526. Similarly, graphical map representation 523 can be refreshed to reflect topology changes or path changes, for example, by selecting the “Redraw Graphics” button 525 or the graphical map representation 523 may be automatically refreshed by the NMS software.

According to one embodiment, the graphical map representation 523 includes current performance monitoring data values 524 for a particular signal direction, e.g., left to right or right to left. In such an embodiment, the signal direction can be flipped by choosing the “Left to Right” or “Right to Left” radio buttons 521. In other embodiments, the graphical map representation 523 may include current performance monitoring data values 524 for both signal directions.

Advantageously in this manner, a network management system employing embodiments of the present invention enable operators to visualize the network in multiple intuitive and easy-to-understand views, such as via the graphical performance monitor viewer 500. Embodiments of the present invention also enable operators to detect degradation in performance and correct problems before they result in network outage.

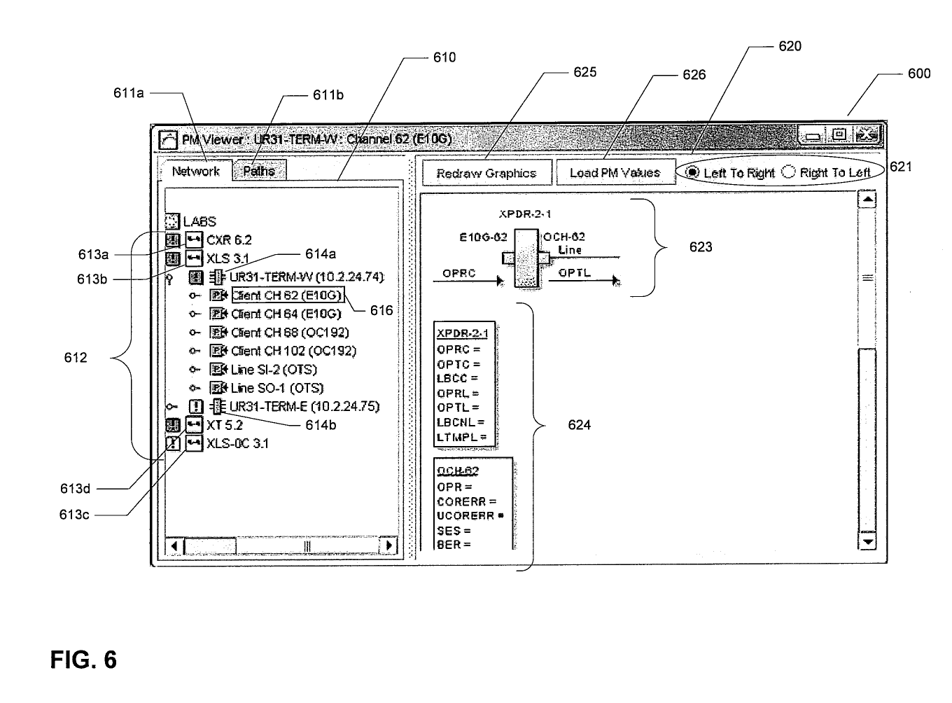

FIG. 6 is another screen shot of a graphical performance monitor viewer 600 of a network management system in accordance with embodiments of the present invention. Similar to the example described with reference to FIG. 5, the graphical performance monitor viewer 600 includes two distinct windows, (i) a tree hierarchy window 610, which can contain a graphical depiction of either a network tree or a path tree depending upon the selected tab 611a or 611b and (ii) a map window 620. In the present example, the “Network” tab 611a is the active tab for the tree hierarchy window 610 and thus the tree hierarchy window 610 depicts a network tree hierarchy 612 in accordance with a network model, representing physical elements and groups of physical elements rather than logical entities in contrast to the path tree hierarchy 512 of FIG. 5.

The network tree hierarchy 612 depicts all subnetworks 613a-d of the service provider network being managed by the network management system. By expanding a subnetwork, e.g., subnetwork 613b, NOC personnel are able to view all network elements, e.g., terminal equipment 614a and 614b, that are part of the parent subnetwork. In one embodiment, the network elements can be further expanded to reveal all client and line ports 615 that belong to the parent network element.

Map window 620 provides a graphical map representation 623 of the selected object (e.g., client port 616) in the network tree hierarchy 612. In one embodiment, the graphical map representation 623 includes only the network element or one or more relevant components thereof which are associated with the selected object. In some embodiments, physically adjacent network elements and/or logical objects associated with the selected object may also be graphically depicted. In the present example, the graphical map representation includes only the optical line card (e.g., transponder, such as XPDR-2-1) associated with the selected client port 616.

As was the case in connection with map window 520 discussed with reference to FIG. 5, in the present example, under each graphic object of graphical map representation 623, a collection of current performance monitoring data values 624 are shown for the corresponding element. As discussed with reference to FIG. 5, the current performance monitoring data values 624 may include all or a subset of performance monitoring data points associated with the selected object.

As discussed with reference to FIG. 5, the current performance monitoring data values 624 can be refreshed by selecting the “Load PM Values” button 626. Similarly, graphical map representation 623 can be refreshed by selecting the “Redraw Graphics” button 625 or the graphical map representation 623 may be automatically refreshed by the NMS software.

According to one embodiment, the graphical map representation 623 includes current performance monitoring data values 624 for a particular signal direction, e.g., left to right or right to left. In such an embodiment, the signal direction can be flipped by choosing the “Left to Right” or “Right to Left” radio buttons 621. In other embodiments, the graphical map representation 623 may include current performance monitoring data values 624 for both signal directions.

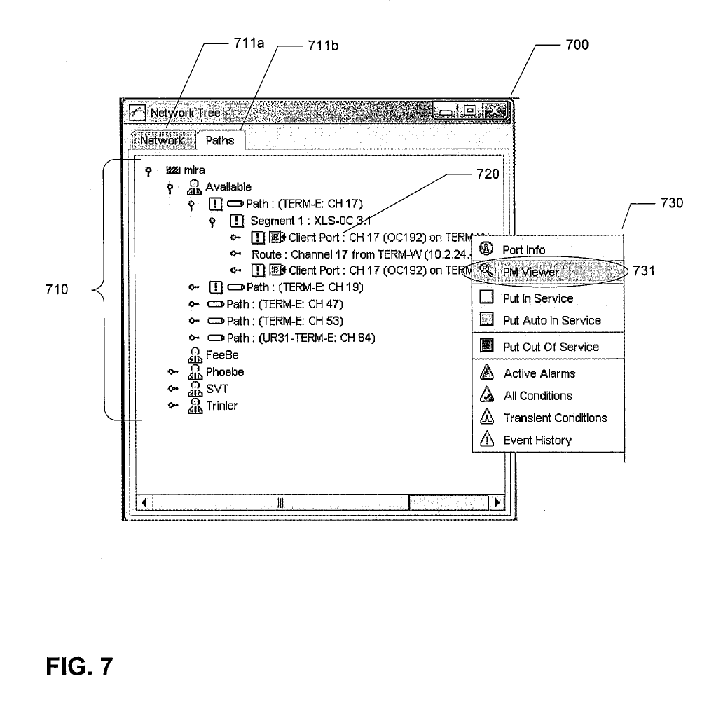

FIG. 7 illustrates invocation of a performance monitor viewer from a path model representation of a network tree 710 in accordance with embodiments of the present invention. According to one embodiment of the present invention, the network management system includes a network tree viewer 700 that can depict a hierarchical representation of service provider network in the form of either a network tree or a path tree depending upon the selected tab 711a or 711b. In the present example, the “Path” tab 711b is the active tab for the network tree viewer 700 thus the network tree 710 represents a hierarchical structure in accordance with the path model discussed previously.

According to the present example, a graphical performance monitor viewer, such as graphical performance monitor viewer 500 or 600, can be launched from the network tree 710. For example, an operator may right click a mouse on a selected object (e.g., client port 720) in the network tree 710 to bring up a popup menu, such as popup menu 730. Then, the operator may select the “PM Viewer” menu option 731 from the popup menu 730 to launch the graphical performance monitor viewer for the selected object. In one embodiment, the graphical performance monitor viewer includes both a tree hierarchy window (e.g., tree hierarchy window 510 or 610) and a map window (e.g., map window 520 or 620). In other embodiments, the graphical performance monitor viewer launched in this manner only includes a map window (e.g., map window 520 or 620).

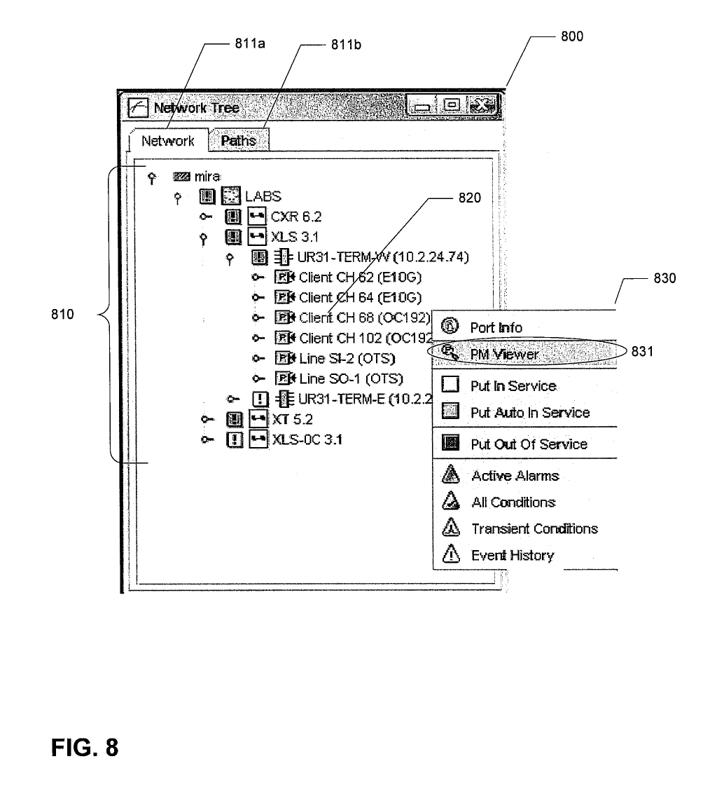

FIG. 8 illustrates invocation of a performance monitor viewer from a network model representation of a network tree in accordance with embodiments of the present invention. According to one embodiment of the present invention, the network management system includes a network tree viewer 800 that can depict a hierarchical representation of service provider network in the form of either a network tree or a path tree depending upon the selected tab 811a or 811b. In the present example, the “Network” tab 811a is the active tab for the network tree viewer 800 thus the network tree 810 represents a hierarchical structure in accordance with a network model representing physical elements and groups of physical elements rather than logical entities in contrast to the network tree 710 of FIG. 7.

According to the present example, a graphical performance monitor viewer, such as graphical performance monitor viewer 500 or 600, can be launched from the network tree 810. For example, an operator may right click a mouse on a selected object (e.g., client port 820) in the network tree 810 to bring up a popup menu, such as popup menu 830. Then, the operator may select the “PM Viewer” menu option 831 from the popup menu 830 to launch the graphical performance monitor viewer for the selected object. As indicated earlier, the graphical performance monitor viewer may include both a tree hierarchy window (e.g., tree hierarchy window 510 or 610) and a map window (e.g., map window 520 or 620). Alternatively, the graphical performance monitor viewer launched in this manner may exclude the tree hierarchy window.

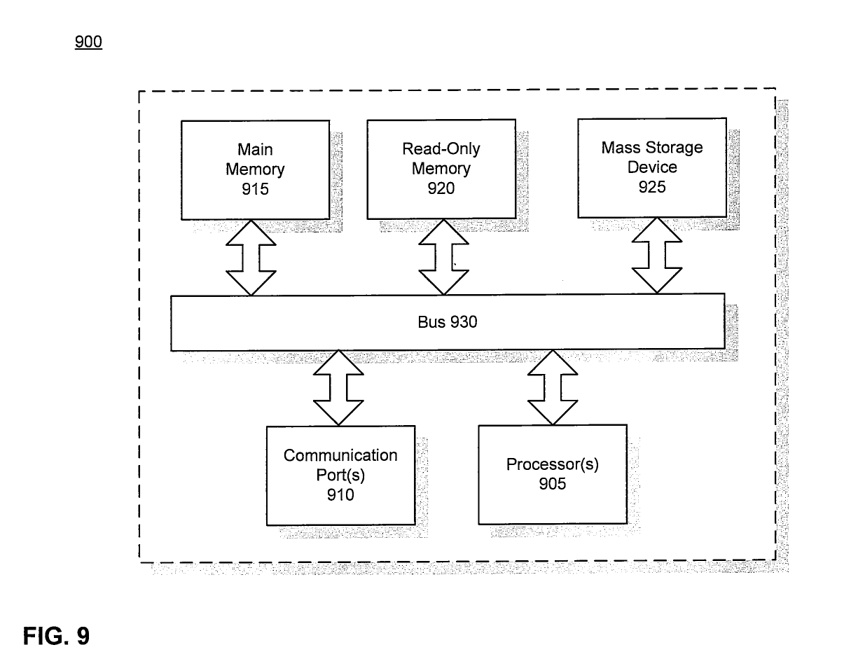

FIG. 9 is an example of a computer system with which embodiments of the present invention may be utilized. Embodiments of the present invention include various steps, which will be described in more detail below. A variety of these steps may be performed by hardware components or may be embodied in machine-executable instructions, which may be used to cause a general-purpose or special-purpose processor programmed with instructions to perform these steps. Alternatively, the steps may be performed by a combination of hardware, software, and/or firmware. As such, FIG. 9 is an example of a computer system 900, such as a workstation, personal computer, laptop, a network management system, such as the Xtera 8600 NMS™ available from Xtera Communications, Inc.), client or server (e.g., an intermediate element management system, such as the Xtera 8500 EMS™ or the Xtera 8300 EMS™ both of which are available from Xtera Communications, Inc.), upon which or with which embodiments of the present invention may be employed.

According to the present example, the computer system includes a bus 930, one or more processors 905, one or more communication ports 910, a main memory 915, a removable storage media 940, a read only memory 920 and a mass storage 925.

Processor(s) 905 can be any future or existing processor, including, but not limited to, an Intel® Itanium® or Itanium 2 processor(s), or AMD® Opteron® or Athlon MP® processor(s), or Motorola® lines of processors. Communication port(s) 910 can be any of an RS-232 port for use with a modem based dialup connection, a 10/100 Ethernet port, a Gigabit port using copper or fiber or other existing or future ports. Communication port(s) 910 may be chosen depending on a network, such a Local Area Network (LAN), Wide Area Network (WAN), or any network to which the computer system 900 connects.

Main memory 915 can be Random Access Memory (RAM), or any other dynamic storage device(s) commonly known in the art. Read only memory 920 can be any static storage device(s) such as Programmable Read Only Memory (PROM) chips for storing static information such as start-up or BIOS instructions for processor 905.

Mass storage 925 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 930 communicatively couples processor(s) 905 with the other memory, storage and communication blocks. Bus 930 can include a bus, such as a Peripheral Component Interconnect (PCI)/PCI Extended (PCI-X), Small Computer System Interface (SCSI), USB or the like, for connecting expansion cards, drives and other subsystems as well as other buses, such a front side bus (FSB), which connects the processor(s) 905 to system memory.

Optionally, operator and administrative interfaces, such as a display, keyboard, and a cursor control device, may also be coupled to bus 930 to support direct operator interaction with computer system 900. Other operator and administrative interfaces can be provided through network connections connected through communication ports 910.

Removable storage media 940 can be any kind of external hard-drives, floppy drives, IOMEGA® Zip Drives, Compact Disc—Read Only Memory (CD-ROM), Compact Disc Re-Writable (CD-RW), Digital Video Disk—Read Only Memory (DVD-ROM).

Components described above are meant only to exemplify various possibilities. In no way should the aforementioned exemplary computer system limit the scope of the invention.

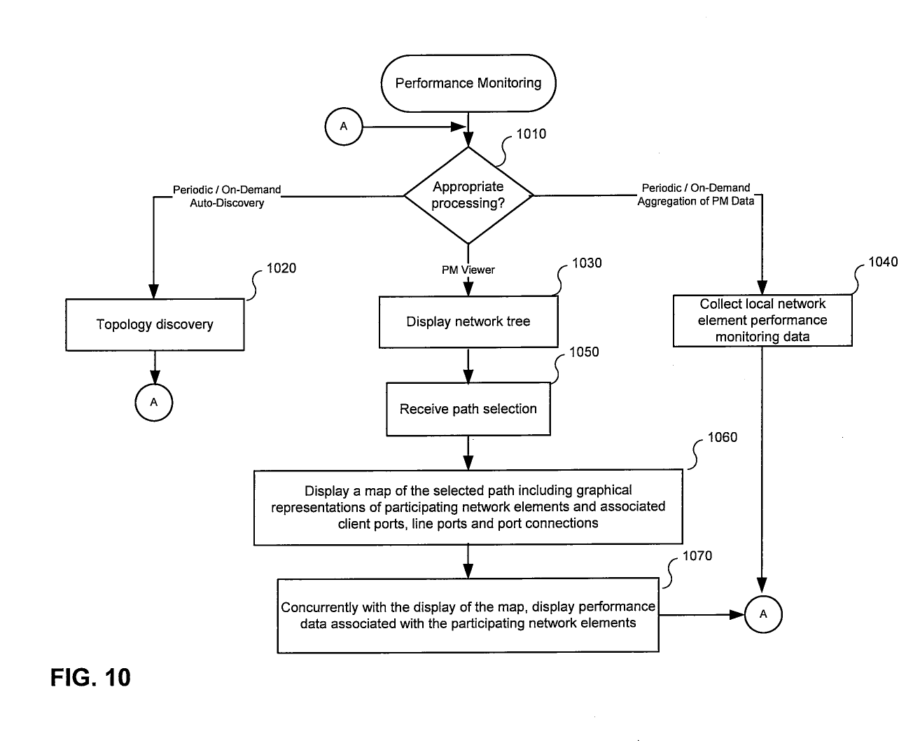

FIG. 10 is a flow diagram illustrating performance monitoring processing in accordance with embodiments of the present invention. Depending upon the particular implementation, the various process and decision blocks described herein may be performed by hardware components, embodied in machine-executable instructions, which may be used to cause a general-purpose or special-purpose processor programmed with the instructions to perform the steps, or the steps may be performed by a combination of hardware, software, firmware and/or involvement of human participation/interaction.

At decision block 1010, the network management system (NMS) determines appropriate processing to perform. In one embodiment of the present invention, processor(s) 905 may receive interrupts on a periodic basis to trigger various processing, such as auto-discovery, aggregation of performance monitoring data from network elements within the service provider network and the like). Such interrupts may be received, for example, every 5 to 15 minutes. Alternatively, the interrupts may be received whenever the values of performance monitoring data go outside of predetermined or configurable ranges. Furthermore, interrupts may be received upon availability of new or changed performance monitoring data at the network elements. Such interrupts may be received using any interrupt scheme known in the art including, but not limited to, using a polling scheme where processor(s) 905 periodically review interrupt registers, or using asynchronous interrupt ports of processor(s) 905. Alternatively or additionally, the processor(s) 905 may proactively request performance monitoring data be provided from the network elements on a periodic or as needed basis (e.g., operator requested “Load PM Values”). Based on the disclosure provided herein, one of ordinary skill in the art will recognize a variety of interrupt and/or polling mechanisms that may be used in relation to different embodiments of the present invention. Depending upon the current state of the interrupt and/or polling mechanism employed, performance monitoring processing branches to block 1020, 1030 or 1040.

At block 1020, the NMS or an intermediate element management system (EMS) discovers the service provider network's fiber and WDM topology. According to one embodiment, this topology discovery process involves the network elements auto-discovering and communicating with each other using a standards-based control plane, e.g., a Generalized Multiprotocol Label Switching (GMPLS) control plane, or a proprietary control plane. In such an environment, including GMPLS-capable network elements, the NMS or the intermediate EMS simply connect to a single gateway network element to learn and automatically upload details of the topology, equipment and configuration of the service provider network. After completion of the topology discovery process, performance monitoring processing continues with decision block 1010.

At block 1040, the NMS collects performance monitoring data relating to the network elements of the service provider network. The performance monitoring data may be stored locally on the individual network elements or the performance monitoring data may have been pre-aggregated and stored by an intermediate EMS. After collecting the performance monitoring data, performance monitoring processing continues with decision block 1010.

At block 1030, responsive to receipt of a request to display a network tree, for example, the NMS causes a hierarchical representation of the network tree to be presented on a display device in accordance with a predetermined or operator selectable model (e.g., a network (physical) model or a path (logical) model). In one embodiment, the hierarchical representation of the network tree is as shown in FIG. 5, FIG. 6, FIG. 7 or FIG. 8. It is to be understood, however, that various alternative network tree representations are possible.

At block 1050, information is received regarding a selected object, e.g., a path, for which a graphical map representation, e.g., graphical map representation 523 or 623, and associated performance monitoring data is desired. As indicated earlier, exemplary mechanisms through with the indication regarding the selected object may be received include, but are not limited to, selection of an object displayed in a network tree, such as those depicted in FIG. 5, FIG. 6, FIG. 7 or FIG. 8, by a user of the NMS.

At block 1060, assuming the selected object is a path, according to the present example, a graphical map representation of the selected path is displayed including graphical representations of participating network elements and associated client ports, line ports and port connections. In one embodiment, a graphical performance monitor viewer interface screen may concurrently display a tree hierarchy window (e.g., tree hierarchy window 510 or 610), depicting the network tree and the selected object, and a map window (e.g., map window 520 or 620), depicting the graphical map representation corresponding to the selected path. In other embodiments, the graphical map representation may be displayed on a screen separate and apart from the network tree from which it was launched or requested.

At block 1070, responsive to selection of an object, responsive to a “Load PM Values” request, or the like, currently available performance monitoring data is displayed for the network elements associated with the selected path, for example, concurrently with the depiction of the graphical map representation. Depending upon the implementation, the performance monitoring data may be automatically updated as new data becomes available or the performance monitoring data may be refreshed upon request by the NMS user. After the performance monitoring data values are displayed along with the graphical map representation, performance monitoring processing continues with decision block 1010.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method comprising:
receiving information regarding a selected path of a plurality of paths associated with a plurality of network elements that are part of a service provider network;
responsive to receipt of the information regarding the selected path, displaying a map of the selected path including (i) graphical representations of participating network elements of the plurality of network elements that are associated with the selected path and (ii) graphical representations of client ports, line ports and port connections associated with the participating network elements; and
along with the map, displaying information regarding performance data associated with the participating network elements, the performance data including optical power levels upon entry to and exit from each of the participating network elements.

2. The method of claim 1, wherein said displaying information regarding performance data associated with the participating network elements comprises displaying the information for a first signal direction.

3. The method of claim 2, further comprising responsive to a user request displaying the information for a second signal direction.

4. The method of claim 1, wherein the plurality of network elements include terminal equipment and wherein said displaying a map of the selected path further comprises displaying one or more optical line cards associated with participating terminal equipment that are associated with the selected path.

5. The method of claim 1, wherein the plurality of network elements include one or more of terminal equipment, optical amplifiers, optical add/drop multiplexers (OADMs) and optical cross-connects (OXCs).

6. The method of claim 1, wherein the service provider network comprises a dense wavelength-division multiplexing (DWDM) transport network.

7. A method comprising:
receiving performance data associated with a plurality of network elements that are part of a service provider network, the performance data including information regarding optical power levels at one or more performance monitoring data points associated with the plurality of network elements;
causing a graphical depiction to be presented illustrating the plurality of network elements and their physical interconnections via respective line ports and client ports of the plurality of network elements; and
concurrently with the graphical depiction, causing information regarding the received performance data to be displayed.

8. The method of claim 7, further comprising receiving information regarding a selected path of a plurality of paths through the service provider network and wherein the plurality of network elements are those network elements within the service provider network that are associated with the selected path.

9. The method of claim 7, wherein said causing information regarding the received performance data to be displayed comprises displaying the information for a first signal direction.

10. The method of claim 9, further comprising displaying the information for a second signal direction.

11. The method of claim 7, wherein the service provider network comprises a wavelength-division multiplexing (WDM), a coarse WDM (CWDM) or a dense WDM (DWDM) transport network.

12. The method of claim 11, wherein the plurality of network elements includes one or more of terminal equipment, optical amplifiers, optical add/drop multiplexers (OADMs) and optical cross-connects (OXCs).

13. A network management system comprising:
a storage device having stored thereon one or more routines operable to collect and display performance data associated with network elements of a service provider network; and
one or more processors coupled to the storage device configured to execute the one or more routines to cause (i) a map of a selected path and (ii) information regarding performance data associated with participating network elements of the network elements that are associated with the selected path to be concurrently presented to an end user, where
the end user identifies the selected path from a plurality of paths associated with the network elements;
the map includes (i) graphical representations of the participating network elements and (ii) graphical representations of client ports, line ports and port connections associated with the participating network elements; and
the information regarding performance data includes optical power levels upon entry and exit from each of the participating network elements.

14. A program storage device readable by one or more processors of a network management system, tangibly embodying a program of instructions executable by the one or more processors to perform method steps for displaying performance data associated with network elements associated with a selected path, said method steps comprising:
receiving information regarding a selected path of a plurality of paths associated with a plurality of network elements that are part of a service provider network;
responsive to receipt of the information regarding the selected path, displaying a map of the selected path including (i) graphical representations of participating network elements of the plurality of network elements that are associated with the selected path and (ii) graphical representations of client ports, line ports and port connections associated with the participating network elements; and
along with the map, displaying information regarding performance data associated with the participating network elements, the performance data including optical power levels upon entry and exit from each of the participating network elements.
